(19) United States
(12) Patent Application Publication
(10) Pub. No.: US 2017/0015343 A1
(43) Pub. Date: Jan. 19, 2017

(54) Rocking Apparatus

(71) Applicant: EKIDE, S.L., Arrasate-Mondragon (ES)

(72) Inventors: Xabier DIEZ FERNANDEZ, Arrasate-Mondragon (Gipuzkoa) (ES); Iosu ERRASTI BASABE, Eskoriatza (Gipuzkoa) (ES)

(21) Appl. No.: 15/207,962

(22) Filed: Jul. 12, 2016

(30) Foreign Application Priority Data
Jul. 13, 2015 (EP) 15382363.8

(51) Int. Cl. B62B 9/22

(52) U.S. Cl. CPC B62B 9/22

(57) ABSTRACT

An apparatus for imparting movement to a baby carrying device, such as, for example the rocking of a baby stroller. According to one embodiment the apparatus includes a motor with a motor shaft, a drive for directly causing the rocking movement of the stroller based on the rotation of the motor shaft, and a mechanism which is attached to the motor shaft and the drive for transmitting the rotation of the motor shaft to said drive in the form of rocking movement. The drive is suitable for being coupled to a stroller wheel and comprises two facing arms holding the wheel between them. The distance between the arms is adjustable so that the drive may be adapted to wheels of different thicknesses.

### CROSS-REFERENCE TO RELATED APPLICATIONS

This application relates to and claims the benefit and priority to European Patent Application No. 15382363, filed Jul. 13, 2015.

### TECHNICAL FIELD

The present invention relates to apparatuses for rocking devices for babies for the purpose of calming the baby or putting the baby to sleep comfortably in said device.

### BACKGROUND

Rocking a baby stroller is known to cause an effect on babies calming them and/or putting them to sleep. Under normal conditions, a person is responsible for rocking the stroller to cause its rocking movement, which can be a tiring and uncomfortable operation for said person.

Devices automatically causing said rocking movement are known, such that the person responsible for rocking the stroller only needs to associate said device with the stroller in order to generate the desired effect on the baby, making their work easier. Most known devices are not easy to handle, particularly as regards their manageability, so the use thereof is limited exclusively to home.

Devices solving this problem, such as that disclosed in patent document WO2009031145A2, are also known. The device disclosed in this patent document comprises a motor with a motor shaft, a drive for directly causing the rocking movement of the stroller based on the rotation of the motor shaft, and a mechanism which is attached to the motor shaft and the drive for transmitting the rotation of the motor shaft to said drive in the form of rocking movement. The drive corresponds with a curved platform on which a stroller wheel is arranged, and the mechanism causes repetitive swinging of the platform in both directions, in response to the rotation of the motor shaft. This movement of the drive causes the rocking movement of the stroller wheel of which is arranged on said platform.

### SUMMARY OF THE DISCLOSURE

According to some embodiments an apparatus is provided that comprises a motor with a motor shaft, a drive for directly causing the rocking movement of, for example, a stroller based on the rotation of the motor shaft, and a mechanism which is attached to the motor shaft and the drive for transmitting the rotation of the motor shaft to said drive in the form of rocking movement. The actuation of the motor (the rotation of the motor shaft) is carried out to cause the rocking movement of the stroller which, by means of the mechanism and the drive, is transmitted to the stroller.

According to some embodiments the drive is suitable for being coupled to a stroller wheel and comprises two facing arms for holding the wheel between them. Both arms are movable to move closer to or farther from one another in a direction of movement for being adapted in this manner to the different thicknesses of the wheel. Different brands and models of baby strollers are known on the market, and as a result baby strollers with wheels of a different diameter and thickness are also known. With the drive used, the apparatus can be adapted to different types of wheels, making it a universal solution for rocking baby strollers. The drive furthermore allows gripping the wheel, the apparatus being coupled to the stroller, and not simply associating the wheel to the apparatus, such that rocking the baby stroller in the conditions and in the manner desired is assured without any risk of unwanted stroller movements (tilting, for example) which may negatively affect the effect to be produced on the baby.

Furthermore, this coupling can be done in a manner that is very simple for the user and without having to lift the stroller, for example, to associate the apparatus with the stroller as occurs in the state of the art, which is very uncomfortable at times due to the weight of the stroller. The drive used also assures the stability of the stroller since it is not arranged under a wheel like in the state of the art, which causes inclination of the stroller, or at least gives an impression of a safer and more stable stroller when using the apparatus, improving how users or possible users view said apparatus.

These and other advantages and features will become evident in view of the drawings and the detailed description.

### BRIEF DESCRIPTION OF THE DRAWINGS

FIG. 1 shows a perspective view of an embodiment of a rocking apparatus coupled to the wheel of a baby stroller.

FIG. 2 shows a perspective view of the apparatus of FIG. 1, without the wheel and without part of the cover thereof.

FIG. 3a shows in detail the drive of the apparatus of FIG. 1, whereby said apparatus is coupled to the baby stroller, with the drive being closed.

FIG. 3b shows in detail the drive of the apparatus of FIG. 1, whereby said apparatus is coupled to the baby stroller, with the drive being open.

FIG. 4a shows a perspective view of the apparatus of FIG. 1 without part of the cover thereof, with the second arm in the most extended position.

FIG. 4b shows a perspective view of the apparatus of FIG. 1 without part of the cover thereof, with the second arm in the most retracted position.

FIG. 4c shows a perspective view of the apparatus of FIG. 1 without part of the cover thereof, with the second arm in an intermediate position.

FIG. 5a shows the attachment point of the first arm with the second arm of the mechanism of the apparatus of FIG. 1, in the position closest to a support surface of said apparatus.

FIG. 5b shows the attachment point of FIG. 5a in the position farthest from the support surface of the apparatus of FIG. 1.

FIG. 6 shows a controller that controls the motor in communication with the motor and a stop position detector.

### DETAILED DESCRIPTION

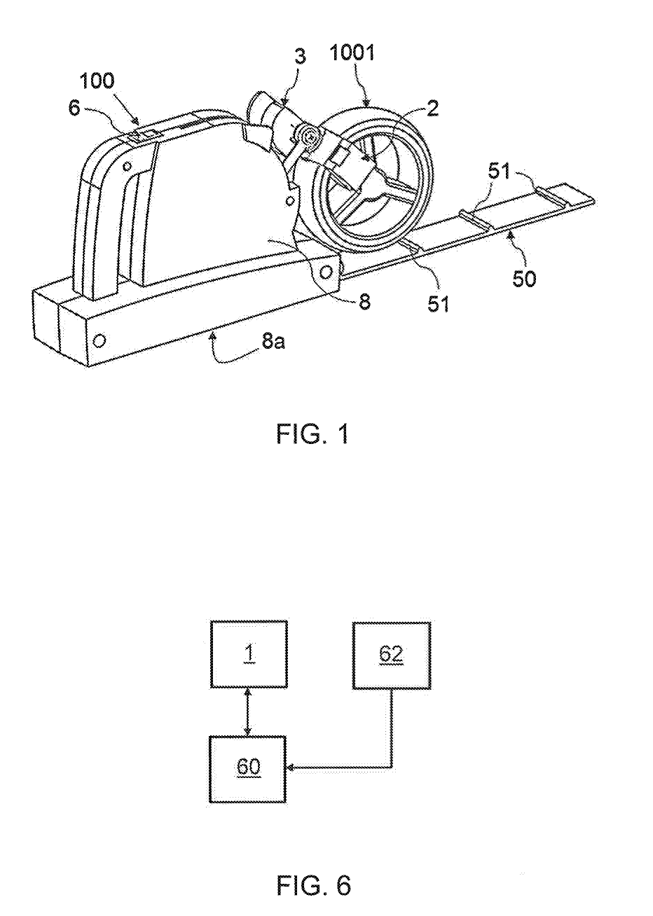

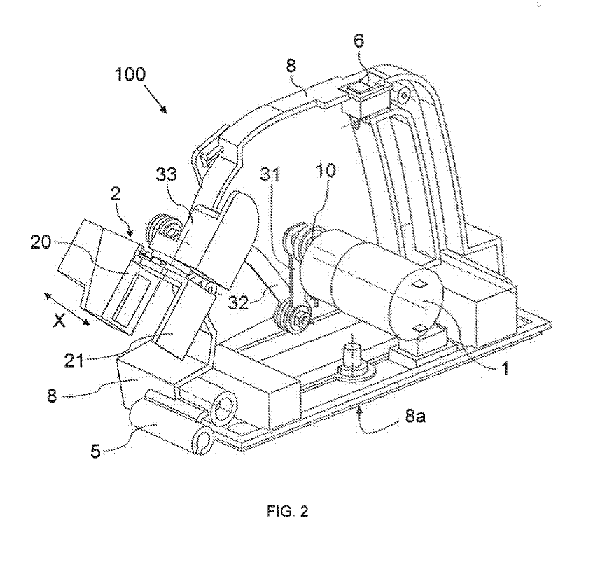

FIG. 1 shows one embodiment of an apparatus 100 for rocking baby strollers or other baby carrying devices. The apparatus 100 comprises a motor 1 with a motor shaft 10 shown by way of example in FIG. 2, a drive 2 for directly causing the rocking movement of the stroller based on the rotation of the motor shaft 10, and a mechanism 3 which is attached to the motor shaft 10 and the drive 2 for transmitting the rotation of the motor shaft 10 to said drive 2 in the form of rocking movement. The motor 1 and the motor shaft 10 as well as part of the mechanism 3 are protected by a cover 8.

To cause the rocking movement of the stroller, the actuation of the motor 1, which comprises a motor shaft 10, may rotate in a single direction. Rotating in a single direction allows using a more cost-effective motor 1. According to one embodiment, the actuation of the motor 1 is carried out by means of a switch 6 comprised in the apparatus 100 and arranged in the apparatus 100 such that it is easily accessible for a user. The mechanism 3 transforms the rotation of the motor shaft 2 into movement of the drive 2 in a cyclical forward and backward movement direction, and the drive 2 transfers this movement to the stroller which rocks.

According to some embodiments the drive 2 comprises two facing arms 20 and 21 suitable for gripping a stroller wheel 1001 between them like a clamp. This means that the user can easily associate the apparatus 100 with the stroller, coupling it to the stroller as described above. The arms 20 and 21 can comprise a surface with conditions suitable for maintaining the coupling without any risk of the wheel accidentally coming free (or at least for reducing the risk thereof), such as a rough surface and/or a surface made of a specific material (a skid-proof material, for example).

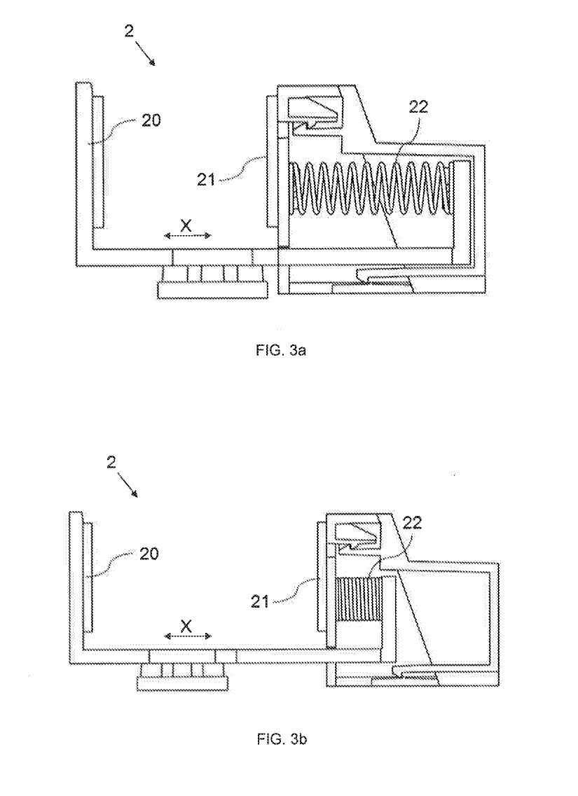

According to some embodiments both arms 20 and 21 are furthermore movable to move closer to or farther from one another in a direction of movement X for being adapted to the different thicknesses of wheel 1001, which allows obtaining a universal apparatus 100 as described above. One of the arms 20 or 21 may be static whereas the other arm 20 or 21 is the arm which can move. According to one embodiment the drive 2 comprises a spring 22 to allow relative movement between both arms 20 and 21 in the direction of movement X, as shown in FIGS. 3a and 3b, and use of a spring 22 furthermore allows firmly strengthening the coupling between the wheel 1001 and the drive 2, making the accidental decoupling thereof difficult and therefore improving the safety of the apparatus 100.

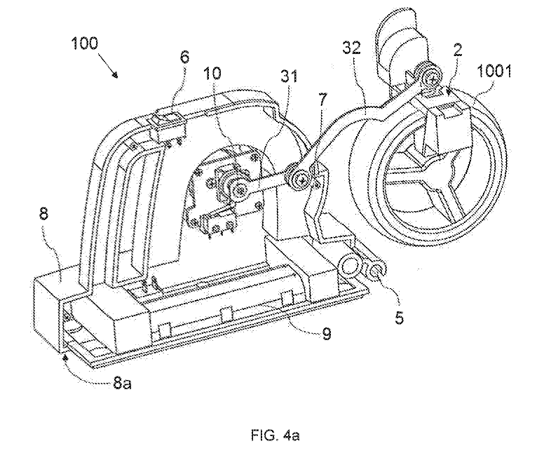

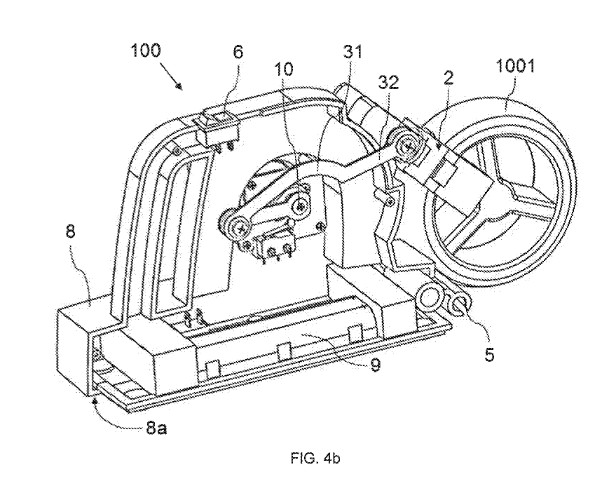

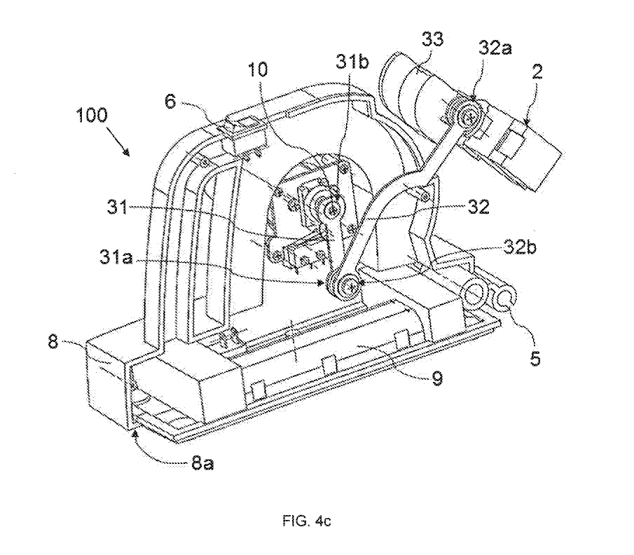

According to some embodiments a structure is formed by three elements 31, 32 and 33, as can be seen in FIGS. 4a, 4b and 4c: a first arm 31 which is fixed to the rotating shaft 10 of the motor 1 through an attachment point 31b, a second arm 32 which is fixed with freedom of rotation to the first arm 31 through an attachment point 31a spaced from the attachment point 31b, and a member 33 which is attached with freedom of rotation to the second arm 32 at an attachment point 32a of the second arm 32 spaced from the attachment point 32b through which said second arm 32 is attached to the first arm 31. The drive 2 is fixed to the part 33, such that said drive 2 replicates the movement of the member 33. By fixing the second arm 32 to an attachment point 31a of the first arm 31 spaced from the rotating shaft 10, an eccentric rotation of the second arm 32 with respect to the motor shaft 10 is generated. This eccentric rotation causes a back and forth movement (rocking movement) of the attachment point 32a of said second arm 32, which is transmitted to the member 33 and therefore to the drive 2. The rocking movement is transmitted from the drive 2 to the stroller when a wheel 1001 thereof has been coupled to the drive 2.

When the motor shaft 10 rotates, the first arm 31 rotates with it. The rotation of the first arm 31 causes an eccentric rotation of the attachment point 32a of the second arm 32 due to its attachment with the first arm 31. FIGS. 4a, 4b and 4c show three different positions of the attachment point 32a of the second arm 32. Therefore, in order to generate the rocking movement the member 33 does not have to be included between the drive 2 and the second arm 32, but the presence of said member 33 provides the drive 2 with freedom of rotation with respect to the second arm 32, and coupling is thereby generated between the apparatus 100 and the wheel 1001 allowing rotation of the wheel 1001 without problems during the rocking movement thereof, unlike what could happen if the drive 2 were attached in a fixed manner to the second arm 32. The member 33 therefore allows transmitting the rocking movement of the second arm 32 to the drive 2, and furthermore allows the rotation of said drive 2 for the suitable movement of the wheel 1001. A safe, comfortable and simple rocking movement of the stroller is therefore achieved for calming the baby and/or for putting the baby to sleep in the stroller. As it is used only to provide rotation to the drive 2 with respect to the second arm 32, the length of the member 33 is not relevant and its inclusion does not negatively affect the size of the apparatus 100 (does not increase the size thereof).

The first arm 31 is used for causing movement of the second arm 32 in both directions and its length determines the distance travelled by the stroller when it performs the rocking movement, such that the manufacturer can decide its length depending on the movement desired for the stroller. Specifically, what generically determines said distance is the distance between the point of said first arm 31 where the second arm 32 is fixed and the point of said first arm 31 which is fixed to the motor shaft 10 (which, according to some embodiments, coincides with the length of the first arm 31).

According to some embodiments the length of the second arm 32 is determined so that its attachment point 32a remains outside the cover 8 (which will have a hole not shown in the drawings to allow the second arm 32 to extend therethrough), and so that the movement of the member 33 is not affected by said cover 8 (and therefore by the drive 2 or the wheel 1001).

According to some embodiments, the attachment points 31a and 31b, 32a and 32b of the arms 31 and 32 are ends of said arms 31 and 32, respectively.

According to some embodiments, the apparatus 100 comprises a control unit for controlling the motor 1, such that the rotational speed of its motor shaft 10 and therefore the rocking speed can be regulated. The apparatus 100 can therefore comprise different options to be selected by the user thereof, which allows adapting the rocking conditions to each baby in particular.

The apparatus 100 can further comprise at least one device, by way of a limit switch comprising, for example, elements 40, 40a, 40b, 41, 41a. The limit switch is associated with a stop position of the motor shaft 10 and is also referred to herein as a stop position detector. In the embodiments with at least one limit switch, the apparatus 100 comprises a control unit 60 communicated with the limit switch 62. The control unit 60 may be the same control unit which allows adjusting the speed of the motor shaft 10, such that said embodiments may include the option of adjusting said speed.

With the limit switch, the rotation of the motor shaft 10 in the apparatus 100 is stopped when it is detected that the shaft is in a specific angular position (the stop position), provided that it has been ordered to stop, such that regardless of when it is ordered to stop, the control unit causes the stop only when it detects that said motor shaft 10 is in said stop position (under normal operating conditions). This allows stopping the apparatus 100 in the same position at all times, regardless of when it is ordered to stop, which can result in many advantages. The stop position can be arbitrarily chosen or a specific stop position, such as, for example, the position in which the second arm 32 is retracted the most and the apparatus 100 occupies a smaller space, can be selected.

According to some embodiments, the selection of the position S is not arbitrary but it has not been selected depending on the criterion mentioned in the preceding paragraph either, as described below. The limit switch allows knowing when the rotating shaft of the motor 10 is in the stop position (an angular position). As described, the position of the attachment point 32a of the second arm 32 in said travel depends on the angular position of the motor shaft 10, such that the limit switch is indirectly associated with a stop position of said attachment point 32a, corresponding with a stop position of the stroller during the rocking movement thereof. The maximum power consumption of the motor 1 occurs in the moment it is activated, in the moment in which the motor shaft 10 starts to rotate to cause the rocking movement of the stroller. The value of this initial power consumption depends on the force that the motor 1 must apply in that moment to start the rocking movement of the stroller, and it has been verified that the lowest consumption occurs when the attachment point 32a of the second arm 32 is in an intermediate position (when the first arm 31 is arranged perpendicular to the support surface 8a of the apparatus 100, which surface is used for supporting the apparatus 100 on the ground), i.e., when the attachment point 32a of said second arm 32 is in mid-travel (in any direction). The second arm 32 can therefore be in two different positions in those conditions depending on the corresponding rocking direction (the first arm 31 in a vertical position with respect to the support surface 8a, with the attachment point 31a in the position farthest from the support surface 8a, or the first arm 31 in the vertical position with respect to the support surface 8a, with the attachment point 31a in the position closest to the support surface 8a). According to some embodiments, the stop position is associated with the arrangement of said attachment point 31a in the position closest to the support surface 8a of the second arm 32 and it is the position shown in FIG. 4c, such that it is assured that the maximum power consumption of the motor 1 in the moment of start-up will always be the lowest possible (under normal operating conditions). This allows using low-power motors 1 with the subsequent cost reduction in the motor 1 and therefore in the apparatus 100, and with the subsequent size reduction of the motor 1 and therefore of the apparatus 100.

According to some embodiments the apparatus 100 further comprises a projection 7 on which the second arm 32 is supported when it is in the position corresponding with the stop position, such that the motor 1 has to withstand less stress when it is not being used, which can be beneficial for increasing its service life. The second arm 32 can comprise a curved segment which is to be supported on the projection 7, and as a result of said curved shape of said segment, the movement of the second arm 32 is not negatively affected during normal operation of the apparatus 100.

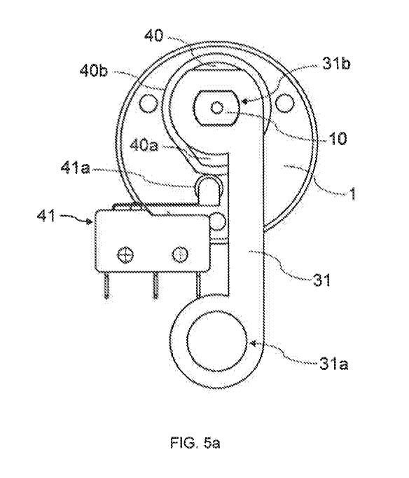

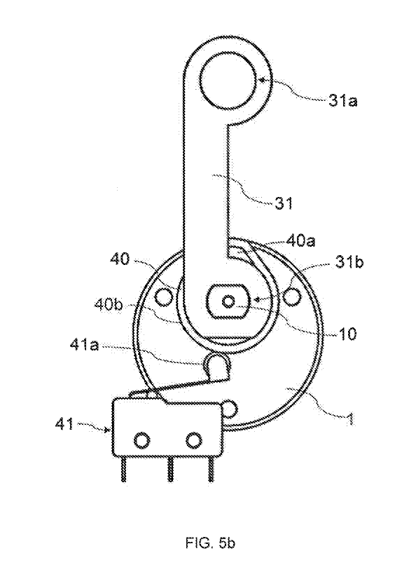

According to some embodiments, the limit switch comprises a member 40 which is fixed to the motor shaft 10 as shown in FIGS. 5a and 5b and rotates integrally with said motor shaft 1. The limit switch also comprises a device 41 cooperating with the member 40 when the motor shaft 10 is in the stop position which, in the preferred embodiment, corresponds with the position of said rotating shaft 10 when the first arm 31 is in the vertical position, with the attachment point 31a in the position closest to the support surface 8a (said position is depicted in FIG. 5a). The device 41 is communicated with the control unit, such that when it cooperates with the member 40, the control unit detects that the motor shaft 10 is in the stop position.

In any of the embodiments the apparatus 100 can further comprise a coupling 5 and a platform 50 which is shown in FIG. 1, for example, and which is coupled to said coupling 5, the wheel 1001 being arranged on the platform 50. Said platform 50 comprises at least one alteration 51 on its surface on which the wheel 1001 moves for producing the feeling of there being bumps or uneven terrain while rocking the stroller, which can improve the desired effect on the baby.

In any of the embodiments the apparatus 100 can further comprise a battery 9 for powering the motor 1. Furthermore, the battery 9 can be rechargeable and the apparatus 100 would comprise in this case a connection to allow recharging same. The apparatus 100 can further comprise a power grid connection to enable powering the motor 1 from a power grid, which can also be used for recharging the battery 9.

Clause 1: According to some embodiments an apparatus is provided for rocking baby strollers or other devices for babies comprising wheels, comprising a motor 1 with a motor shaft 10, a drive 2 for directly causing the rocking movement of the stroller based on the rotation of the motor shaft 10, and a mechanism 3 which is attached to the motor shaft 10 and the drive 2 for transmitting the rotation of the motor shaft 10 to said drive 2 in the form of rocking movement, the drive 2 is suitable for being coupled to a stroller wheel 1001 and comprises two facing arms 20, 21 for holding the wheel 1001 between them, both arms 20, 21 being movable to move closer to or farther from one another in a direction of movement (X), for being adapted to the different thicknesses of the wheel 1001.

Clause 2: According to some embodiments an apparatus according to clause 1 is provided, wherein the drive 2 comprises a spring 22 to allow relative movement between both arms 20, 21 in the direction of movement (X).

Clause 3: According to some embodiments an apparatus according to clause 1 or 2 is provided, wherein the mechanism 3 comprises a first arm 31 which is fixed to the rotating shaft 10 of the motor 1 through a first attachment point 31b, a second arm 32 which is fixed with freedom of rotation to the first arm 31 through a second attachment point 31a spaced from the first attachment point 31b, and a member 33 attached to the drive 2 and fixed with freedom of rotation to the second arm 32.

Clause 4: According to some embodiments an apparatus according to clause 3 is provided, wherein the distance of the first arm 31 between the attachment points 31a, 31b of the first arm 31 defines the length of travel of the stroller during the rocking movement thereof, said distance being selected for producing the desired travel.

Clause 5: According to some embodiments an apparatus according to any of the preceding clauses is provided that comprises a device, by way of a limit switch, and a control unit communicated with the device and the motor 1, the device being suitable for indicating to the control unit that the motor shaft 10 is in a stop position, the control unit being configured for causing the stop of the motor 1 when it detects that the motor shaft 10 is in the stop position, once said stop has been ordered.

Clause 6: According to some embodiments an apparatus according to clause 5 is provided, wherein the device comprises a first element 40 which is fixed to the motor shaft 10 and rotates integrally with said motor shaft 10, and a second element 41 cooperating with the member 40 when the motor shaft 10 is in the desired position, the control unit being configured for detecting said cooperation.

Clause 7: According to some embodiments an apparatus according to clause 6 is provided, wherein the first element 40 of the device comprises an actuation area 40a projecting from its outer surface 40b, and the second element 41 of said device comprises an actuation area 41a arranged with respect to the first element 40 such that both actuation areas 40a, 41a contact one another when the motor shaft 10 is in the end position, the first element 40 furthermore being fixed to the motor shaft 10 such that its actuation area 40a coincides with the stop position.

Clause 8: According to some embodiments an apparatus according to any of clauses 5 to 7 is provided, wherein the stop position of the device corresponds with a position of the motor shaft 10 in which the drive 2 is in mid-travel.

Clause 9: According to some embodiments an apparatus according to clause 8 is provided that comprises a support surface 8a which is used for supporting the apparatus 100 on the ground, the stop position of the rotating shaft 10 corresponding with an arrangement of the first arm 31 perpendicular to the support surface 8a.

Clause 10: According to some embodiments an apparatus according to clause 9 is provided, wherein, in the arrangement of the first arm 31 perpendicular to the support surface (8a) corresponding with the stop position of the motor shaft 10, the point of the first arm 31 to which the second arm 32 is fixed is in its position closest to the support surface 8a.

Clause 11: According to some embodiments an apparatus according to any of clauses 5 to 10 is provided that comprises a switch 6 whereby the motor 1 can be activated and stopped, the switch being communicated with the control unit.

Clause 12: According to some embodiments an apparatus according to any of clauses 5 to 10 is provided that comprises a projection 7 on which the second arm 32 is supported when it is in the position corresponding with the stop position, said second arm 32 comprising a curved segment which is supported on the projection 7.

Clause 13: According to some embodiments an apparatus according to any of the preceding clauses is provided that comprises a coupling 5 and a platform 50 coupled to said coupling 5 on which the wheel 1001 is arranged, the platform 50 comprising at least one alteration 51 on its surface on which the wheel 1001 moves.

What is claimed is:

1. An apparatus for imparting movement to a baby carrying device, the apparatus comprising:
a motor with a rotating motor shaft,
a first arm having first and second ends, the first end being coupled to the motor shaft,
a second arm having a first and second ends, the first end of the second arm being coupled to the second end of the first arm,
a drive coupled with the second end of the second arm, the drive configured to be attached to a part of the baby carrying device and to impart movement to the baby carrying device when the motor shaft rotates,
a stop position detector for detecting a stop position of the motor shaft; and
a controller in communication with the motor and the stop position detector, the controller configured to order the motor to stop and then to cause the motor to stop when the stop position detector detects the motor shaft to be in the stop position after the stop has been ordered by the controller.

2. An apparatus according to claim 1, wherein the drive comprises first and second facing arms, the first and second facing arms being movable in order to change a distance between the first and second facing arms, the first arm being urged toward the second arm by a spring.

3. An apparatus according to claim 1, wherein the first end of the first arm is coupled to the rotating shaft of the motor through a first attachment point, the first end of the second arm coupled with freedom of rotation to the second end of the first arm through a second attachment point spaced from the first attachment point.

4. An apparatus according to claim 3, further comprising a member attached to the drive and coupled with freedom of rotation to the second end of the second arm.

5. An apparatus according to claim 3, wherein the distance between the first and second attachment points of the first arm is selected for producing a desired travel of the drive.

6. An apparatus according to claim 1, wherein the stop position detector comprises a first element which is fixed to the motor shaft and rotates with the motor shaft, and a second element not attached to the motor shaft that is configured to cooperate with the first element when the motor shaft is in the stop position.

7. An apparatus according to claim 6, wherein the first element comprises a projecting actuation area, and the second element comprises an actuation area arranged with respect to the first element such that both the projecting actuation area of the first element and the actuation area of the second element contact one another when the motor shaft is in the stop position.

8. An apparatus according to claim 1, wherein the drive travels between a first position and a second position, when in the first position the drive is located closest to the motor shaft, when in the second position the drive is located furthest from the motor shaft, the stop position corresponding with a position of the motor shaft in which the drive is located between the first and second positions.

9. An apparatus according to claim 1, further comprising a support surface which is used for supporting the apparatus on a ground surface, the motor shaft being in the stop position when the first arm is positioned perpendicular to the support surface.

10. An apparatus according to claim 9, wherein when the first arm is positioned perpendicular to the support surface the second end of the first arm to which the first end of the second arm is coupled is in a travel position closest to the support surface.

11. An apparatus according to claim 1, further comprising a projection on which the second arm is supported when in the position corresponding with the stop position, the second arm comprising a curved segment which is supported on the projection.

12. An apparatus according to claim 1, further comprising a platform that is extendable from a first end of the apparatus, the platform comprising a surface with at least one alteration.

13. An apparatus according to claim 1, wherein the baby carrying device is a stroller and the part to which the drive is configured to be attached is a wheel of the stroller.

14. An apparatus for imparting movement to a baby carrying device, the apparatus comprising:
a motor with a rotating motor shaft,
a drive configured to be attached to a part of the baby carrying device and to impart movement to the baby carrying device when the motor shaft rotates, the drive comprising first and second facing arms, the first arm being movable in order to change a distance between the first and second facing arms, the first arm being urged toward the second arm by a spring; and
a mechanism coupled to the motor shaft and to the drive, the mechanism configured to transmit a rotation of the motor shaft to the drive in the form of a rocking movement.

15. An apparatus according to claim 14, wherein the mechanism includes first and second arms, each of the first and second arms having a first end and a second end, the first end of the first arm being coupled to the motor shaft, the first end of the second arm being coupled to the second end of the first arm, the second end of the second arm being coupled to the drive, the apparatus further comprising:
a stop position detector for detecting a stop position of the motor shaft; and
a controller in communication with the motor and the stop position detector, the controller configured to order the motor to stop and then to cause the motor to stop when the stop position detector detects the motor shaft to be in the stop position after the stop has been ordered by the controller.

16. An apparatus according to claim 14, wherein the stop position detector comprises a first element which is fixed to the motor shaft and rotates with the motor shaft, and a second element not attached to the motor shaft that is configured to cooperate with the first element when the motor shaft is in the stop position.

17. An apparatus according to claim 15, wherein the drive travels between a first position and a second position, when in the first position the drive is located closest to the motor shaft, when in the second position the drive is located furthest from the motor shaft, the stop position corresponding with a position of the motor shaft in which the drive is located between the first and second positions.

18. An apparatus according to claim 15, further comprising a support surface which is used for supporting the apparatus on a ground surface, the motor shaft being in the stop position when the first arm is positioned perpendicular to the support surface.

19. An apparatus according to claim 18, wherein when the first arm is positioned perpendicular to the support surface the second end of the first arm to which the first end of the second arm is coupled is in a travel position closest to the support surface.

20. An apparatus according to claim 15, further comprising a projection on which the second arm is supported when in the position corresponding with the stop position, the second arm comprising a curved segment which is supported on the projection.
